(19) United States
(12) Patent Application Publication
(10) Pub. No.: US 2025/0165750 A1
(43) Pub. Date: May 22, 2025

(54) STORAGE SYSTEMS FOR LARGE LANGUAGE MODEL FINE-TUNING

(71) Applicant: Western Digital Technologies, Inc., San Jose, CA (US)

(72) Inventors: Ariel Navon, Revava (IL); Alexander Bazarsky, Holon (IL); Eran Sharon, Rishon Lezion (IL)

(21) Appl. No.: 18/513,600

(22) Filed: Nov. 19, 2023

(51) Int. Cl. G06N 3/0455

(52) U.S. Cl. CPC G06N 3/0455

(57) ABSTRACT

Data is received from an application, and it is determined whether the received data is to be used for fine-tuning a Large Language Model (LLM). The received data is stored in a primary storage or in a secondary storage based at least in part on whether the received data is to be used for fine-tuning the LLM. The secondary storage is configured to store data that is less frequently accessed than data stored in the primary storage. In response to determining that the received data is to be used for fine-tuning the LLM, the received data is stored in the secondary storage. In one aspect, a query for information is received that is associated with particular data stored in the secondary storage and the query is input into the LLM to provide the information without accessing the particular data stored.

### BACKGROUND

A Large Language Model (LLM) is a type of Artificial Intelligence (AI) that can process textual queries to respond with natural language. LLMs are typically trained using large amounts of text and can be used for a wide variety of tasks, including, for example, translation, writing, and question answering. LLMs have several properties that distinguish them from other Al models. First, they are extremely large, with some LLMs having over a hundred billion parameters to allow the LLMs to represent a very large number of possible relationships between words and concepts. Second, LLMs are trained using massive datasets to allow the LLMs to learn the statistical regularities of language, as well as the meaning of words and phrases. Third, LLMs are able to generate human-quality or natural language text due to the LLMs learning the structure of language, including grammar and punctuation.

LLMs can be used by the public at large, such as with ChatGPT developed by OpenAI and Bard developed by Google. However, LLMs can also be used by specific groups, such as, for example, within a company or a university, or by a particular department or group of users in an organization. Such LLMs may be specially trained to better answer queries from particular groups of users, such as doctors, programmers, or researchers in a certain field, for example. Training LLMs from scratch is generally a very complicated and expensive task that can include, for example, many months of training using thousands of processing nodes, such as Graphics Processing Units (GPUs). However, the vast majority of cost and computations are incurred during a first stage of training, referred to as “pre-training.”

The pre-training can be followed by one or more “fine-tuning” stages that are lighter in computations, cost, time, and the amount of data used. The fine-tuning may be used to train the LLM to a specific user application or for a specific group of users. Despite typically needing a smaller amount of data for fine-tuning, fine-tuning often still requires relatively large amounts of data that can be expensive for a particular organization or group of users to store and maintain. In addition, there is a need to better streamline fine-tuning of LLMs for particular organizations or groups of users.

### BRIEF DESCRIPTION OF THE DRAWINGS

The features and advantages of the embodiments of the present disclosure will become more apparent from the detailed description set forth below when taken in conjunction with the drawings. The drawings and the associated descriptions are provided to illustrate embodiments of the disclosure and not to limit the scope of what is claimed.

FIG. 1 is a block diagram of an example storage system for fine-tuning a Large Language Model (LLM) according to one or more embodiments.

FIG. 2A is a block diagram of a first portion of a distributed storage system for fine-tuning an LLM according to one or more embodiments.

FIG. 2B is a block diagram of a second portion of the distributed storage system of FIG. 2A according to one or more embodiments.

FIG. 3 is a flowchart for a data storage process according to one or more embodiments.

FIG. 4 is a flowchart for a query process according to one or more embodiments.

FIG. 5 is a flowchart for a data migration process according to one or more embodiments.

### DETAILED DESCRIPTION

In the following detailed description, numerous specific details are set forth to provide a full understanding of the present disclosure. It will be apparent, however, to one of ordinary skill in the art that the various embodiments disclosed may be practiced without some of these specific details. In other instances, well-known structures and techniques have not been shown in detail to avoid unnecessarily obscuring the various embodiments.

### Example System Environments

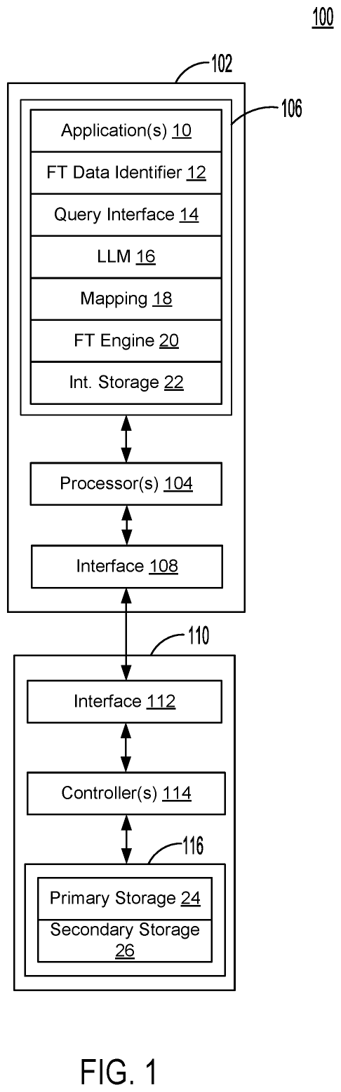

FIG. 1 illustrates an example storage system 100 for fine-tuning a Large Language Model (LLM) according to one or more embodiments. As shown in FIG. 1, storage system 100 includes host device 102 and storage device 110. In some implementations, host device 102 and storage device 110 can form, for example, a computer system, such as a desktop, laptop, notebook, tablet, or client and server. In this regard, host device 102 and storage device 110 may be housed separately, such as where host device 102 may be a client accessing storage device 110 as a server. In other implementations, host device 102 and storage device 110 may be housed together as part of a single electronic device, such as, for example, a network media player, Set-Top Box (STB), Digital Video Recorder (DVR), or Network Attached Storage (NAS). In other implementations, host device 102 and storage device 110 may not be co-located and may be in different geographical locations.

Host device 102 includes one or more processors 104, interface 108, and one or more local memories 106. Processor(s) 104 can include, for example, circuitry such as one or more Central Processing Units (CPUs), Graphics Processing Units (GPUs), microcontrollers, Digital Signal Processors (DSPs), Application-Specific Integrated Circuits (ASICs), Field Programmable Gate Arrays (FPGAs), hard-wired logic, analog circuitry and/or a combination thereof. In some implementations, processor(s) 104 can include a System on a Chip (SoC) that may be combined with one or more memories 106 of host device 102 and/or interface 108. In the example of FIG. 1, processor(s) 104 execute instructions, such as instructions from application(s) 10, FT data identifier 12, query interface 14, LLM 16, and FT engine 20.

Host device 102 can communicate with storage device 110 using interface 108 via a bus or network, which can include, for example, a Compute Express Link (CXL) bus, Peripheral Component Interconnect express (PCIe) bus, a Network on a Chip (NoC), a Local Area Network (LAN), or a Wide Area Network (WAN), such as the internet or another type of bus or network. In this regard, interface 108 can include a network interface card in some implementations. In some examples, host device 102 can include software for controlling communication with storage device 110, such as a device driver of an operating system of host device 102.

As shown in the example of FIG. 1, host device 102 includes its own local memory or memories 106, which can include, for example, a Dynamic Random Access Memory (DRAM), Static Random Access Memory (SRAM), Magnetoresistive RAM (MRAM) or other type of Storage Class Memory (SCM), or other type of solid-state memory.

While the description herein refers to solid-state memory generally, it is understood that solid-state memory may comprise one or more of various types of memory devices such as flash integrated circuits, NAND memory (e.g., Single-Level Cell (SLC) memory, Multi-Level Cell (MLC) memory (i.e., two or more levels), or any combination thereof), NOR memory, EEPROM, Chalcogenide RAM (C-RAM), Phase Change Memory (PCM), Programmable Metallization Cell RAM (PMC-RAM or PMCm), Ovonic Unified Memory (OUM), Resistive RAM (RRAM), Ferroelectric Memory (FeRAM), MRAM, 3D-XPoint memory, and/or other discrete Non-Volatile Memory (NVM) chips, or any combination thereof.

In the example of FIG. 1, memory or memories 106 of host device 102 store one or more applications 10, Fine-Tuning (FT) data identifier 12, query interface 14, Large Language Model (LLM) 16, mapping 18, Fine-Tuning (FT) engine 20, and intermediate storage 22. In this regard, application(s) 10, FT data identifier 12, query interface 14, LLM 16, mapping 18, FT engine 20, and intermediate storage 22 can include computer-executable instructions or modules and/or data used by such computer-executable instructions or modules.

Application(s) 10 can include user applications executing on host device 102 that may create, modify, store, or otherwise access data, such as a word processing program, an email program, or a document viewing and/or editing program, for example. As discussed in more detail below, data stored, created, modified, or accessed by such applications can be used to fine-tune LLM 16. In some implementations, particular applications 10 may be separately identified for providing textual samples for fine-tuning LLM 16 over other applications that may not be used for fine-tuning LLM 16. For example, a web browser executed by host device 102 may not supply textual samples for fine-tuning LLM 16 while FT data identifier 12 may analyze and flag or otherwise identify documents accessed by a document viewer for textual samples to be used for fine-tuning LLM 16. FT data identifier 12 in some implementations may then direct the storage of such data from which the textual samples are taken from or that comprise objects or files to be stored in secondary storage 26 after fine-tuning LLM 16 using the textual samples.

As discussed above, LLMs may be specially trained to better answer queries for particular groups of users, such as doctors, programmers, or researchers in a certain field or for users of particular applications. Such special training can include “fine-tuning” to train LLM 16 for one or more specific applications 10 and/or for a group of users of system 100. Despite typically needing a smaller amount of data for fine-tuning LLM 16 as compared to pre-training LLM 16, fine-tuning can still rely on relatively large amounts of data that can be expensive to store and maintain in storage system 100.

LLM 16 in the example of FIG. 1 has been previously trained, such as by using dedicated resources and data outside of storage system 100. As discussed in more detail below, data to be stored from application(s) 10 can be used to fine-tune or further train LLM 16 via FT engine 20 and intermediate storage 22 before being stored in a higher data density, less expensive, and/or slower performance portion of storage 116 of storage device 110 that is shown in FIG. 1 as secondary storage 26. Secondary storage 26 can be a less expensive storage than primary storage 24 in terms of, for example, being able to store more data per given volume of storage media, requiring less hardware, or requiring less power or operations to maintain the integrity of the stored data over time.

In addition, the use of query interface 14 can limit the need to access or retrieve the data used for fine-tuning that is stored in secondary storage 26 because LLM 16 can provide responses related to the data via query interface 14 without accessing the associated data from secondary storage 26, thereby making storage system 100 more efficient in its storage. The overall performance of storage system 100 can also be improved since queries concerning the data stored in secondary storage 26 can be relatively quickly answered by LLM 16 via query interface 14 without accessing data stored in secondary storage 26.

FT data identifier 12 may function as a plug in, extension, application programming interface, or other type of software interface with one or more application(s) 10 to analyze the data being accessed by the one or more application(s) 10 to identify data to be used for fine-tuning LLM 16. In some implementations, FT data identifier 12 can be used by one or more processors 104 of host device 102 to identify data of a particular type, such as journal articles, program code, technical manuals, or legal documents by finding certain words or special characters (e.g., words or characters used in a particular field or programming language). FT data identifier 12 can consider characteristics of the data, such as the application providing the data, a size of the data (e.g., data smaller than a threshold size may not be used since it may not provide enough information for fine-tuning), a file name for the data, an object name for the data, a title for a document included in the data, a format of the data, a file type for the data, an object type for the data, and/or a description or other metadata associated with the data. FT data identifier 12 may also check the ownership of the data or a security setting for the data to confirm that it should be used for fine-tuning LLM 16 since the data may include confidential or private information that should not be shared with a larger group of users.

Query interface 14 enables a user to enter a query or question to be answered or responded to by LLM 16. In some implementations, one or more processors of processors 104 may execute query interface to provide a prompt for a user of host device 102 to enter a textual query for LLM 16. As discussed above, LLMs are trained using large amounts of data to determine relationships and patterns in the data that the LLM has been trained with. In the example of FIG. 1, LLM 16 can provide natural language responses to queries received via query interface 14 by using its encoded training to generate a response based on the query. As opposed to accessing the particular data associated with the query from secondary storage 26, LLM 16 can use the patterns it has learned in the data it was trained with to respond to the query. In some implementations, LLM 16 may be implemented with a certain architecture, such as a transformer architecture that uses an internal encoding of facts for responding to queries received from query interface 14.

The encoded facts or learned patterns may be updated by fine-tuning LLM 16 via FT data identifier 12 and FT engine 20. In this regard, FT data identifier 12 may pass textual samples or entire files or entire objects to FT engine 20 to further train or fine-tune LLM 16. In some implementations, the use of the samples, files, or objects for fine-tuning can be transparent to a user of host device 102. FT data identifier 12 and FT engine 20 can streamline the fine-tuning of LLM 16 as compared to conventional fine-tuning of LLMs that require more human supervision and identification of the training data. In other implementations, the user may be asked to confirm whether data identified by FT data identifier 12 as a candidate for fine-tuning should be used for fine-tuning the LLM. The fine-tuning of LLM 16 can be improved with FT data identifier 12 as compared to conventional fine-tuning by using the actual objects and/or files being accessed by users of host device 102 or by users of particular applications 10 over time to provide training data for fine-tuning that more accurately matches the intended users of LLM 16. In addition, the fine-tuning of LLM 16 can be performed as a background activity of storage system 100 over a longer period of time or as an ongoing fine-tuning so that LLM 16 adapts to the changes in the data being accessed by its users.

When fine-tuning LLM 16, the data being used by FT engine 20 to fine-tune LLM 16 can be stored in intermediate storage 22, which can provide a faster access to the data for fine-tuning as compared to storing such data in storage device 110. In some implementations, intermediate storage 22 may be a portion of one or more memories 106 or may be a separate memory for storing data being used for fine-tuning. The fine-tuning of LLM 16 can take place as a background activity of host device 102 or may be performed during periods of relatively lower activity of processor(s) 104 and/or LLM 16 to reduce the impact of the fine-tuning on the performance of host device 102. As noted above, the fine-tuning of LLM 16 may be an intermittent process that continues through the usable life of storage system 100 so that LLM 16 can adapt to changes in the data being accessed by users of host device 102 to better reflect a current knowledge base.

During the fine-tuning, FT engine 20 may, for example, feed words from sample text in identified data received from FT data identifier 12 into LLM 16 to predict a subsequent word or group of words that can be checked against the actual word or words that follow in the sample text. In this regard, FT engine 20 may format the data received from FT data identifier 12 for fine-tuning LLM 16, such as by formatting the sample text into a particular instruction format and/or size.

In other implementations, the fine-tuning of LLM 16 may be performed externally from storage system 100, such as by a remote server or a cloud service. In such implementations, FT data identifier 12 may provide data identified for fine-tuning LLM 16 to the remote server or cloud service and host device 102 may not include FT engine 20. In yet other implementations, the fine-tuning of LLM 16 may be performed by storage device 110, such as by a dedicated hardware accelerator or computation engine of storage device 110 that can execute FT engine 20 and may include intermediate storage 22.

In the example of FIG. 1, mapping 18 can include a mapping of logical identifiers (e.g., logical addresses) used by host device 102 to identify the files or objects stored in storage device 110. As discussed in more detail below, host device 102 can indicate in mapping 18 whether data is to be stored in secondary storage 26 or primary storage 24 or may update mapping 18 to migrate data from secondary storage 26 to primary storage 24, or vice-versa, based on a frequency of access or a recentness of access, for example. In some implementations, mapping 18 may also include other metadata such as a frequency of access for the data or a most recent access of the data, which may be considered in determining whether to migrate the data from secondary storage 26 to primary storage 24 or vice-versa.

As shown in the example of FIG. 1, storage device 110 includes interface 112, one or more controllers 114, and storage 116. In some implementations, storage device 110 can include, for example, a Solid-State Drive (SSD) that includes solid-state storage media, or a Solid-State Hybrid Drive (SSHD) that includes both solid-state media and rotating magnetic disk media for data storage.

Interface 112 of storage device 110 can communicate with host device 102 using interface 112 via a bus or network, which can include, for example, a CXL bus, PCIe bus, an NoC, a LAN, or a WAN, such as the internet or another type of bus or network. In this regard, interface 112 may include a network interface card in some implementations.

Controller(s) 114 can include, for example, circuitry such as one or more CPUs or other type of processors, microcontrollers, DSPs, ASICs, FPGAs, hard-wired logic, analog circuitry and/or a combination thereof that controls operation of storage device 110. In some implementations, a controller 114 can include an SoC that may be combined with one or more memories of storage device 110 and/or interface 112.

Storage 116 can include one or more memory devices, such as solid-state memory devices and/or hard disk devices. As shown in the example of FIG. 1, storage 116 is partitioned into primary storage 24 and secondary storage 26. In some implementations, data stored in primary storage 24 can be accessed faster than data stored in secondary storage 26. In addition, secondary storage 26 can provide a higher data density than primary storage 24 in some implementations by storing more data in a given volume of storage medium and/or may be a less expensive storage than primary storage 24. As a result, the error correction schemes may differ between primary storage 24 and secondary storage 26 so that more data can be stored in secondary storage 26 and/or so that a less expensive storage or less reliable storage media can be used for secondary storage 26 at a cost of greater latency to access the data as compared to primary storage 24.

One example of such an error correction technique can include using longer codewords for storing data in secondary storage 26 than for data stored in primary storage 24 so that less parity data would need to be stored in secondary storage 26 but would impair random read performance by requiring the entire longer codewords to be read from secondary storage 26 to retrieve a portion of the data represented by the codeword. In some implementations, error correcting capability may be stronger for secondary storage 26 than for primary storage 24 to facilitate less expensive storage media for secondary storage 26, less maintenance operations (e.g., data refreshing or garbage collection), and/or or less power for storing or maintaining data in secondary storage 26 at the expense of a slower performance in reading and/or writing data in secondary storage 26 as compared to primary storage 24.

In this regard, secondary storage 26 may use a slower reading technique in some implementations to increase reliability (e.g., multi-soft bit slow reading) and/or may use a slower writing technique to reduce noise (e.g., smaller programmable voltage step sizes) to compensate for less expensive storage media, less maintenance operations, and/or less power for storing or maintaining data in secondary storage 26 at the expense of a slower performance in reading and/or writing data as compared to primary storage 24.

As another example, the type of storage media used for primary storage 24 may differ from the storage media used for secondary storage 26 to provide a less expensive and/or higher data density storage media at a cost of slower data access performance for secondary storage 26. In such an example, magnetic disks may be used for secondary storage 26 that may have a greater data access latency than a solid-state memory used for primary storage 24, but may provide a higher storage density using technologies, such as Shingled Magnetic Recording (SMR), for example. In other examples, secondary storage 26 may include a magnetic tape for archiving data as opposed to a different type of storage media used for primary storage 24, such as a magnetic disk media or solid-state media.

As yet another example, primary storage 24 and secondary storage 26 may use the same storage media, but may be implemented differently, such as by programming more bits per cell of solid-state memory in secondary storage 26 than in primary storage 24. In such an example, secondary storage 26 can provide a higher data storage density by storing more bits per cell at a cost of slower programming times for writing data to the cell and slower read times to read data from the cell since data would need to be written to and read from the cells in secondary storage 26 at a higher resolution than data for cells in primary storage 24.

The cost of secondary storage 26 may also be reduced as compared to primary storage 24 by, for example, reducing Error Correcting Code (ECC) parallelism for secondary storage 26 so that less decoder hardware is used for secondary storage 26. In some cases, the expense of secondary storage 26 may be reduced by performing ECC calculations externally from storage device 110 of storage system 100, such as by using a cloud service, at a cost of greater latency in accessing data in secondary storage 26.

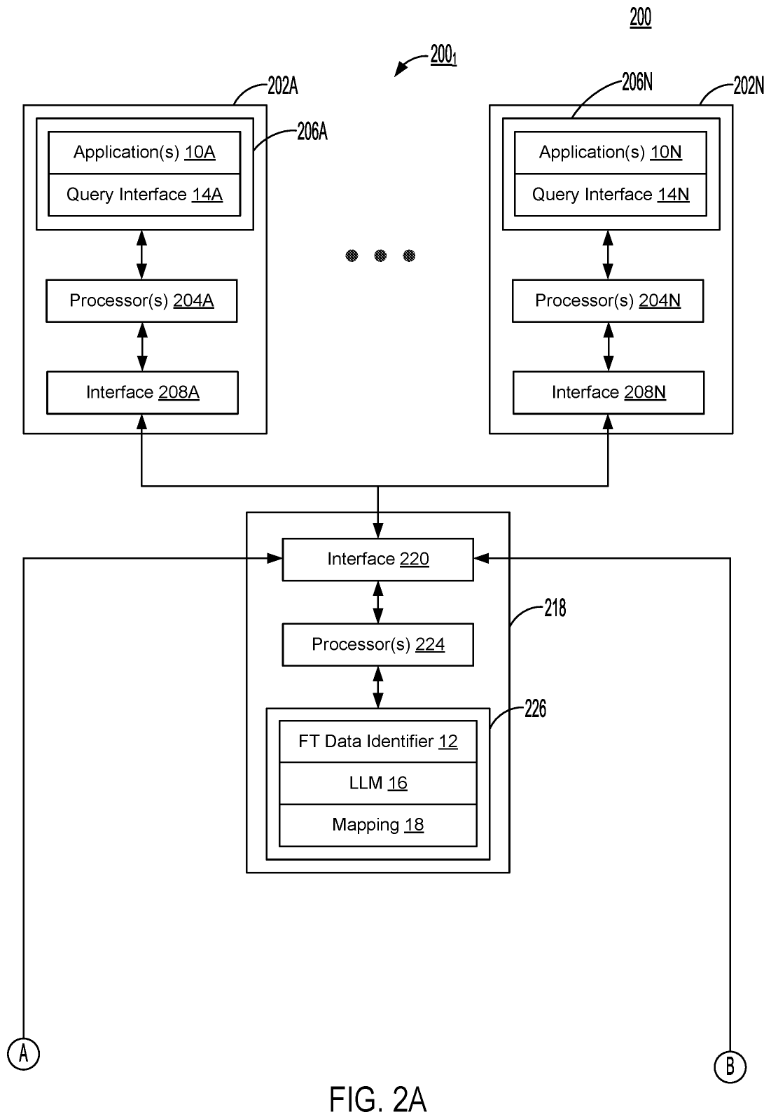

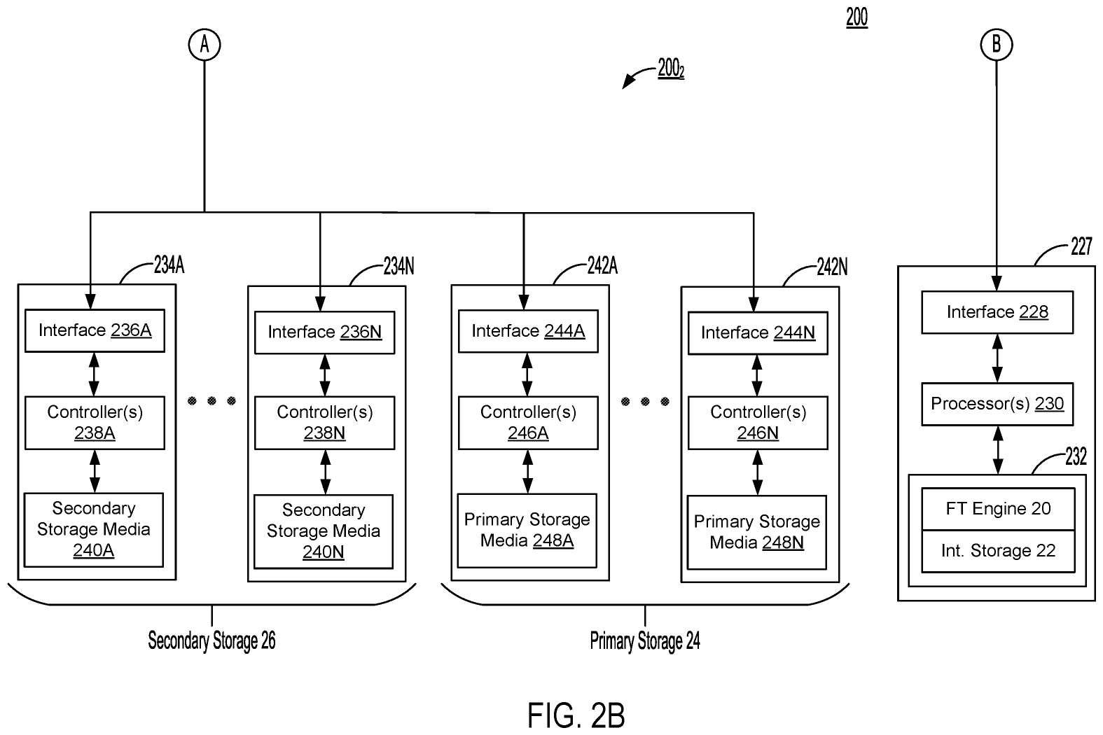

Those of ordinary skill in the art will appreciate with reference to the present disclosure that other implementations of system 100 may differ. For example, other implementations of system 100 may include a separate hardware accelerator or computing device for fine-tuning LLM 16, as in the example of FIG. 2B discussed below. As another example variation, LLM 16 may be stored at a different device than at host device 102 or FT data identifier 12 may be combined with FT engine 20 in other implementations. As yet another example variation, intermediate storage 22 can instead be stored at storage device 110, as opposed to being stored in a memory 106 of host device 102.

FIGS. 2A and 2B provide a block diagram of a distributed storage system 200 for fine-tuning an LLM according to one or more embodiments. FIG. 2A shows a first portion 2001 of the distributed storage system and FIG. 2B shows a second portion 2002 of the distributed storage system, that collectively form distributed storage system 200. Storage system 200 in FIGS. 2A and 2B is distributed in the sense that data is stored across multiple storage devices that may be in one location or may be in different locations. In some implementations, distributed storage system 200 may form part of a data center or multiple data centers.

The storage system of FIGS. 2A and 2B differs from storage system 100 of FIG. 1 in that multiple host devices 202 store data in multiple storage devices that include secondary storage devices 234 and primary storage devices 242. Storage system 200 of FIGS. 2A and 2B also differs from storage system 100 of FIG. 1 in that LLM 16, FT data identifier 12, and mapping 18 are executed or stored at storage system controller 218 and FT engine 20 and intermediate storage 22 are executed or stored at server 227.

Secondary storage 26 in FIG. 2B includes secondary storage devices 234 of a first type and primary storage 24 in FIG. 2B includes primary storage devices 242 of a second type. As discussed in more detail below, the differences between secondary storage devices 234 and primary storage devices 242 can include, for example, the types of storage media used by the storage devices, the data storage density of the storage media, and/or an expense of the storage media in terms of maintenance operations, power, or cost.

As shown in FIG. 2A, host devices 202A to 202N each include an interface 208 (i.e., interfaces 208A to 208N), one or more processors 204 (i.e., processors 204A to 204N), and one or more memories 206 (i.e., memories 206A to 206N). Processors 204 can include, for example, circuitry such as one or more CPUs, GPUs, microcontrollers, DSPs, ASICs, FPGAs, hard-wired logic, analog circuitry and/or a combination thereof. In this regard, each processor 204 may comprise a multi-core processor or each processor 204 can represent a single processing core. In some implementations, a processor 204 can include an SoC that may be combined with one or more memories 206 of a host device 202 and/or an interface 208. Processor(s) 204 execute instructions, such as instructions from application(s) 10 and query interface 14.

Interfaces 208 of host devices 202 communicate with storage system controller 218 via a network, which can include, for example, a LAN or a WAN, such as the internet or another type of network. In this regard, interfaces 208 can include network interface cards in some implementations. In some implementations, host devices 202 can include software for controlling communication with storage system controller 218, such as a device driver in an operating system of the host device 202.

Memories 206 of host devices 202 can include, for example, DRAMs, SRAMs, MRAMs or other type of SCM, or other type of solid-state memory. In the example of FIG. 2A, each memory or memories 206 of host devices 202 store one or more applications 10 (i.e., application(s) 10A and application(s) 10N in FIG. 2A) and a query interface 14 (i.e., query interface 14A and query interface 14N in FIG. 2A). As with the example in FIG. 1, applications 10 in FIG. 2A can include user applications executing on a host device 202 that may create, modify, store, or otherwise access textual data, such as a word processing program, an email program, or a document viewing and/or editing program, for example. The data stored, created, modified, or accessed by such applications can be used to fine-tune or further train LLM 16 executed by storage system controller 218. LLM 16 in the example of FIG. 2A has been previously trained, such as by using dedicated resources and data outside of storage system 200, before being fine-tuned using data from host devices 202.

In some implementations, particular applications 10 may be separately identified for providing data for fine-tuning LLM 16 over other applications that may not be used for fine-tuning LLM 16. For example, a web browser executed by host device 202A may not supply data for fine-tuning LLM 16 while data used by another application executed by host device 202A may be flagged for fine-tuning LLM 16 and eventual storage in secondary storage 26 by storing the data in a secondary storage device 234 shown in FIG. 2B. Unlike the example of FIG. 1, FT data identifier 12 is executed by storage system controller 218, as opposed to a host device. In some implementations, FT data identifier 12 may intercept files or objects received from host devices 202 for storage in a storage device and analyze the files or objects or associated metadata to determine if the file or object should be used for fine-tuning and eventual storage in secondary storage 26.

In addition, each host device 202 in the example of FIG. 2A includes a query interface 14 that allows a user to enter a query or question to be answered or responded to by LLM 16 executed by one or more processors 224 of storage system controller 218. In some implementations, one or more processors 204 of a host device 202 may execute query interface 14 to provide a prompt for a user of the host device 202 to enter a textual query for LLM 16. In the example of FIG. 2A, a query interface 14 executing at a host device 202 sends the query via an interface 208 of the host device 202 to storage system controller 218 to be received by LLM 16.

As opposed to retrieving data associated with the query from secondary storage, LLM 16 can use the patterns it has learned in the data it was trained on to respond to the query. As discussed above with the example of FIG. 1, query interface 14 can limit the need to access or retrieve the data used for fine-tuning or data of the same data type that is stored in secondary storage 26, thereby making distributed storage system 200 more efficient. The overall performance of distributed storage system 200 can also be improved since questions concerning the data stored in secondary storage can typically be quickly answered by LLM 16 via query interface 14 without accessing the data stored in secondary storage 26.

In the example of FIG. 2A, storage system controller 218 includes interface 220, one or more processors 224, and one or more memories 226. Processor(s) 224 can include, for example, circuitry such as one or more CPUs, GPUs, microcontrollers, DSPs, ASICs, FPGAs, hard-wired logic, analog circuitry and/or a combination thereof. In this regard, storage system controller 218 in some implementations may act as a hardware accelerator for identifying data for executing LLM 16 and identifying data for fine-tuning LLM 16. In some implementations, processor(s) 224 can include an SoC that may be combined with one or more memories 226 of storage system controller 218 and/or interface 220. Processor(s) 224 execute instructions, such as instructions from FT data identifier 12 and LLM 16.

FT data identifier 12 executed by storage system controller 218 may function, for example, as an application programming interface, or other type of software interface, such as an extended Berkeley Packet Filter (eBPF) program that analyzes the data being sent for storage from host devices 202 to identify data or portions thereof to be used for fine-tuning LLM 16. In some implementations, FT data identifier 12 can be used by one or more processors 224 of storage system controller 218 to identify data of a particular type, such as journal articles, program code, technical manuals, or legal documents by finding particular words or special characters (e.g., words or characters used in a certain field or programming language) in the data. FT data identifier 12 may consider characteristics of the data, such as an application providing the data, a file name for the data, an object name for the data, or a title for a document included in the data, a format of the data, a file type or an object type for the data, a size of the data, and/or a description or other metadata associated with the data. FT data identifier 12 may also check the ownership of the data or a security setting for the data to confirm that it should be used for fine-tuning LLM 16 since the data may include confidential or private information that should not be shared with a larger group of users.

Mapping 18 stored in memory 226 of storage system controller 218 can include a mapping of logical identifiers (e.g., logical addresses) used by host devices 202 to identify data stored in secondary storage devices 234 of secondary storage 26 and in primary storage devices 242 of primary storage 24. As discussed in more detail below, storage system controller 218 can indicate in mapping 18 whether data is to be stored in a secondary storage device 234 or in a primary storage device 242 or may update mapping 18 to migrate data from a secondary storage device 234 to a primary storage device 242, or vice-versa, based on a frequency of access or a recentness of access, for example. Mapping 18 in some implementations may also indicate the frequency of access or a last access time for the data.

As shown in FIG. 2B, server 227 includes interface 228, one or more processors 230, and one or more memories 232. Processor(s) 230 can include, for example, circuitry such as one or more CPUs, GPUs, microcontrollers, DSPs, ASICs, FPGAs, hard-wired logic, analog circuitry and/or a combination thereof. In this regard, server 227 in some implementations may act as a hardware accelerator for fine-tuning LLM 16. In some implementations, processor(s) 230 can include an SoC that may be combined with one or more memories 232 of server 227 and/or interface 228. Processor(s) 230 can execute instructions, such as instructions from FT engine 20.

Server 227 can communicate with storage system controller 218 using interface 228 via a bus or network, which can include, for example, a CXL bus, PCIe bus, an NoC, a LAN, or a WAN, such as the internet or another type of bus or network. In this regard, interface 228 may include a network interface card in some implementations.

Memory or memories 232 of server 227 can include, for example, DRAM, SRAM, MRAM or other type of SCM, or other type of solid-state memory. In the example of FIG. 2B, memory or memories 232 can store FT engine 20 and intermediate storage 22. LLM 16 can be updated by FT engine 20 executed by one or more processors 230 of server 227. In this regard, FT data identifier 12 executed by storage system controller 218 may send data (e.g., files, objects, or portions thereof) to FT engine 20 to further train or fine-tune LLM 16. In some implementations, the use of the data for fine-tuning can be transparent to users of host devices 202.

In other implementations, the user may be asked to confirm whether data identified by FT data identifier 12 as a candidate for fine-tuning should be used for fine-tuning the LLM. The fine-tuning of LLM 16 can be improved with FT data identifier 12 as compared to conventional fine-tuning by using the actual objects and/or files being accessed by users of host device 102 or by users of particular applications 10 over time to provide training data for fine-tuning that more accurately matches the intended users of LLM 16. In addition, the fine-tuning of LLM 16 can be performed as a background activity of distributed storage system 200 over a longer period of time or as an ongoing fine-tuning so that LLM 16 adapts to the changes in the data being accessed by its users. In the example of FIG. 2B, using a dedicated server 227 for fine-tuning LLM 16 can help reduce the burden on storage system controller 218 in executing the LLM.

When fine-tuning LLM 16, the data being used by FT engine 20 can be stored in intermediate storage 22 at server 227, which can provide a faster access to the data for fine-tuning as compared to storing such data in either primary storage devices 242 of primary storage 24 or in secondary storage devices 234 of secondary storage 26. In some implementations, intermediate storage 22 may be a portion of one or more memories 232 at server 227 or may be a separate memory for storing data being used for fine-tuning.

The fine-tuning of LLM 16 can take place as a background activity of storage system controller 218 or may be performed during periods of relatively lower activity of processor(s) 224 and/or LLM 16 to reduce the impact of the fine-tuning on the performance of LLM 16. As noted above, the fine-tuning of LLM 16 may be an intermittent process that continues through the usable life of distributed storage system 200 so that LLM 16 can adapt to changes in the data being accessed by users of host devices 202 to better reflect a current knowledge base.

During the fine-tuning, FT engine 20 executed by server 227 may, for example, feed words from sample text in identified data received from FT data identifier 12 back into LLM 16 to predict a subsequent word or group of words that can be checked against the actual word or words that follow in the sample text. In this regard, FT engine 20 may format the data received from FT data identifier 12 for fine-tuning LLM 16, such as by formatting the sample text into a particular instruction format and/or size.

In other implementations, the fine-tuning of LLM 16 may be performed by a server or a cloud service external to distributed storage system 200. In such implementations, distributed storage system 200 may not include server 227 such that FT data identifier 12 may provide the data identified for fine-tuning to the external server or cloud service. In yet other implementations, the fine-tuning of LLM 16 may be performed by one or more host devices 202 similar to the example of FIG. 1 or by one or more storage devices 234 and/or 242, which may include a dedicated hardware accelerator or computation engine that can execute FT engine 20 and may include intermediate storage 22.

As shown in the example of FIG. 2B, each secondary storage device 234 (i.e., secondary storage devices 234A to 234N) includes an interface 236 (i.e., interfaces 236A to 236N), one or more controllers 238 (i.e., controllers 238A to 238N), and secondary storage media 240 (i.e., secondary storage media 240A to 240N). In some implementations, secondary storage devices 234 can include, for example, SSDs that use solid-state storage media, Hard Disk Drives (HDDs) that include rotating magnetic disk media, or SSHDs that include both solid-state media and rotating magnetic disk media for data storage.

Interfaces 236 and interfaces 244 of secondary storage devices 234 and primary storage devices 242, respectively, can communicate with host devices 202 via a network, which can include, for example, a LAN or a WAN, such as the internet or another type of network. In this regard, interfaces 236 and 244 may include network interface cards in some implementations.

Controllers 238 and controllers 246 of secondary storage devices 234 and primary storage devices 242, respectively, can include circuitry such as one or more CPUs or other type of processors, microcontrollers, DSPs, ASICs, FPGAs, hard-wired logic, analog circuitry and/or a combination thereof that controls operation of the respective storage device. In some implementations, a controller 238 or a controller 246 can include an SoC that may be combined with one or more memories of the storage device and/or an interface 236 or interface 244.

Secondary storage media 240 of secondary storage 26 can include, for example, one or more memory devices, such as solid-state memory devices and/or rotating magnetic disk devices. In some implementations, data stored in primary storage media 248 of primary storage 24 can be accessed faster than data stored in secondary storage media 240 of secondary storage 26. In addition, secondary storage media 240 can provide a higher data density than primary storage media 248 in some implementations by storing more data in a given volume of the storage media and/or may provide a less expensive storage than primary storage media 248. As a result, the error correction schemes may differ between primary storage 24 and secondary storage 26 as discussed above for storage system 100 of FIG. 1 so that more data can be stored in secondary storage 26 and/or so that a less expensive storage or less reliable storage can be used for secondary storage media 240 at a cost of greater latency to access the data as compared to primary storage media 248.

In one example, a slower reading (e.g., using multi-soft bit slow reads) or a slower writing (e.g., using smaller programmable voltage step sizes) can facilitate using less expensive flash memory for secondary storage media 240, less maintenance operations, and/or less power for storing or maintaining data in secondary storage media 240 at the expense of a slower performance in reading and/or writing data in secondary storage 26 as compared to primary storage 24.

As another example, the type of storage media used for primary storage media 248 may differ from the storage media used for secondary storage media 240 to provide a less expensive and/or higher data density storage media at a cost of slower data access performance for secondary storage 26. In such an example, rotating magnetic disks may be used for secondary storage media 240 that may have a greater data access latency than a solid-state memory used for primary storage media 248, but may provide a higher storage density using technologies, such as SMR, for example. In other examples, secondary storage media 240 may include a magnetic tape for archiving data as opposed to a different type of storage media used for primary storage media 248 with less latency for data access, such as rotating magnetic disk media or solid-state memory media.

As yet another example, primary storage media 248 and secondary storage media 240 may use the same type of storage media, but may be implemented differently, such as by programming more bits per cell of solid-state memory in secondary storage media 240 than in primary storage media 248. In such an example, secondary storage media 240 can provide a higher data storage density by storing more bits per cell at a cost of slower programming times for writing data to the cell and slower read times to read data from the cell since data would need to be written to and read from the cells in secondary storage media 240 at a higher resolution than data for cells in primary storage media 248.

The cost of secondary storage 26 may also be reduced as compared to primary storage 24 by, for example, reducing ECC parallelism for secondary storage 26 at secondary storage devices 234 or storage system controller 218 so that less decoder hardware is used for secondary storage 26. In this regard, the expense of secondary storage 26 may also be reduced by performing ECC calculations externally from storage system 200, such as by using a cloud service, at a cost of greater latency in accessing data in secondary storage 26.

Those of ordinary skill in the art will appreciate with reference to the present disclosure that other implementations of system 200 may differ. For example, LLM 16 may be executed at a different device or at different devices than at storage system controller 218. In some implementations, LLM 16 may be executed at each of host devices 202 or at server 227. As another example variation, FT data identifier 12 may be executed at each host device 202 as in the example of FIG. 1. As yet another example variation, intermediate storage 22 can instead be located at storage system controller 218 or at one or more primary storage devices 242, as opposed to being stored in a memory 232 of server 227. As yet another example variation, other implementations of distributed storage system 200 can include multiple storage system controllers 218, such as separate storage system controllers for secondary storage 26 and for primary storage 24, or may include additional servers 227 for fine-tuning LLM 16.

### Example Processes

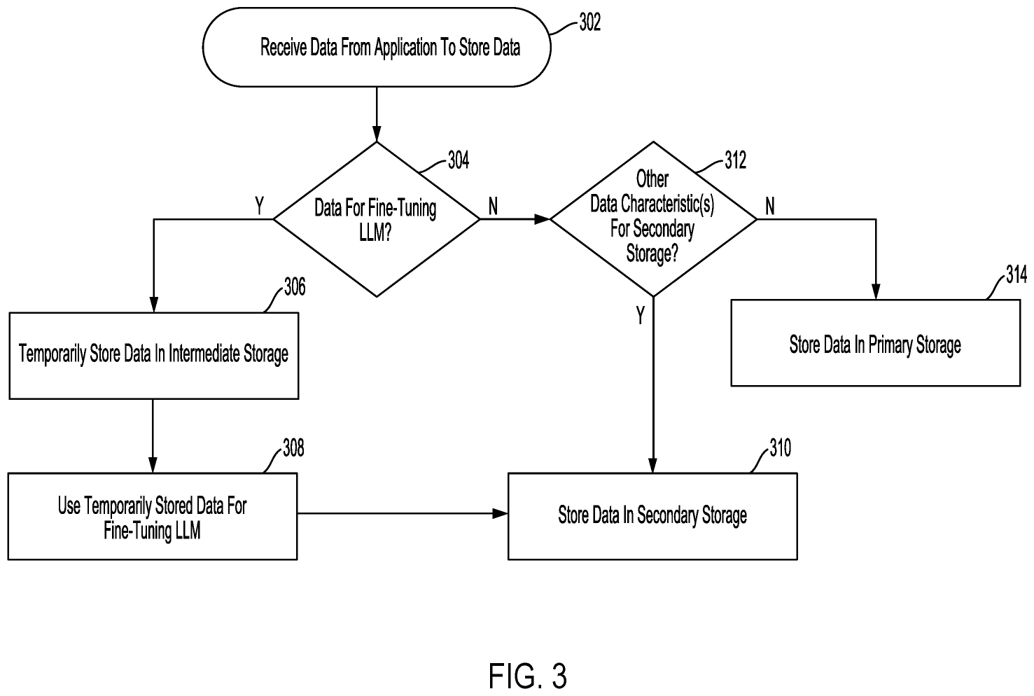

FIG. 3 is a flowchart for a data storage process according to one or more embodiments. The process of FIG. 3 can be performed by, for example, one or more processors 104 of host device 102 executing FT data identifier 12 in FIG. 1 or by one or more processors 224 of storage system controller 218 executing FT data identifier 12 in FIG. 2A.

In block 302, data is received by a processor from an application executing at a host device (e.g., host device 102 in FIG. 1 or a host device 202 in FIG. 2) to store the data in storage. In some cases, the processor executing the application may be the same processor that receives the data for storage. In other cases, the processor that receives the data for storage in block 302 may be located at a different device from the host device executing the application, such as a processor at a storage system controller or a separate server that fine-tunes an LLM. The received data may include, for example, a file or an object that has been created, modified, accessed, or otherwise obtained by the application. In some implementations, the data may only form a portion of an object or file that is to be stored in a storage system.

In block 304, the processor or another processor executing an FT data identifier determines whether the received data is to be used for fine-tuning an LLM. In determining whether the received data is to be used for fine-tuning, characteristics of the data may be considered such as, for example, the application providing the data for storage, a file type or an object type for the data, particular words or special characters in the data, a file name for the data, an object name for the data, or a title for a document included in the data, a size of the data, a format of the data, and/or a description or other metadata associated with the data. In this regard, the FT data identifier may identify objects or files of a particular type, such as journal articles, program code, technical manuals, or legal documents. The FT data identifier may also check the ownership of the data or a security setting for the data to confirm that it should be used for fine-tuning the LLM since the data may include confidential or private information that should not be shared with a larger group of users.

If it is determined in block 304 that the data will be used for fine-tuning, the processor temporarily stores the data in an intermediate storage (e.g., intermediate storage 22 in FIG. 1 or 2B). The use of intermediate storage can allow for the data to be accessed for fine-tuning, such as by an FT engine (e.g., FT engine 20 in FIG. 1 or 2B). In some cases, the intermediate storage can provide a faster access to the data for fine-tuning due to its location by being located closer to the processor performing the fine-tuning and/or due to the type of storage media used for the intermediate storage. This can ordinarily enable a shorter timeframe for fine-tuning the LLM.

In block 308, the data temporarily stored in the intermediate storage is used to fine-tune the LLM. For example, an FT engine may format instructions for the LLM to feed words, sentences, or paragraphs from a sample text into the LLM to predict a subsequent word or group of words that can be checked against the actual word or words that follow in the sample text. In some implementations, the data may be accumulated into a batch of data stored in the intermediate storage that is then used to fine-tune the LLM. The batching of data for fine-tuning can provide a more efficient training process by providing more data for training and better scheduling the fine-tuning so as not to interfere with an expected usage of the LLM. In this regard, the fine-tuning may be performed during periods when the LLM is not in use.

After using the data temporarily stored in the intermediate storage for fine-tuning, the data is stored in secondary storage (e.g., secondary storage 26 in FIG. 1 or 2B) in block 310. As discussed above, after fine-tuning, requests to access the data by the host device or host devices can be reduced due to the fine-tuning since such information will be available via the LLM in many cases. The data can then be stored in a less expensive and/or a higher storage density secondary storage that may have a greater latency in accessing the data as compared to a primary storage of the system (e.g., primary storage 24 in FIG. 1 or 2B).

On the other hand, if it is determined in block 304 that the data received from the application is not to be used for fine-tuning the LLM, a processor determines in block 312 whether the received data should still be stored in secondary storage due to one or more other characteristics of the data. Such other characteristics can include, for example, similar considerations in some cases as those used for determining whether the data is to be used for fine-tuning. The characteristics of the data for determining whether to store the data in secondary storage can include, for example, the application providing the data for storage, a file type or an object type for the data, a file name for the data, an object name for the data, a size of the data, a format of the data, and/or a description or other metadata associated with the data, such as one or more times when the data was previously accessed or an indicator of a frequency of access for the data. In this regard, the determination to store the data in secondary storage may be based on an expected low frequency of access of the data.

If it is determined in block 312 that the data should be stored in secondary storage, the data is stored in the secondary storage in block 310. Alternatively, if it is determined in block 312 that the data should not be stored in secondary storage, the data is stored in a primary storage of the system (e.g., primary storage 24 in FIG. 1 or 2B) in block 314. As discussed above, the primary storage can provide a faster access to data to a host device as compared to data stored in the secondary storage. The primary storage may be used to store data that is expected to be accessed more frequently, whether for modifying the data or reading the data, than data that is stored in secondary storage. As noted above, the use of an LLM can facilitate the storage of more data in a less expensive secondary storage, in terms of material cost per stored gigabyte, power usage, and/or operations required, which can enable a more efficient storage of data by, for example, reducing the amount of primary storage needed by the storage system.

Those of ordinary skill in the art will appreciate that other implementations of the data storage process of FIG. 3 may differ. For example, block 312 may be omitted in implementations where the secondary storage may only be used to store data that is determined to be used for fine-tuning the LLM. As another example variation, a middle tier of storage between the secondary storage and the primary storage may be used to store data that is not used to fine-tune the LLM but is not expected to be accessed frequently. Such a middle tier of storage may provide a storage expense that is between the secondary storage and the primary storage and a data access latency that is between the secondary storage and the primary storage.

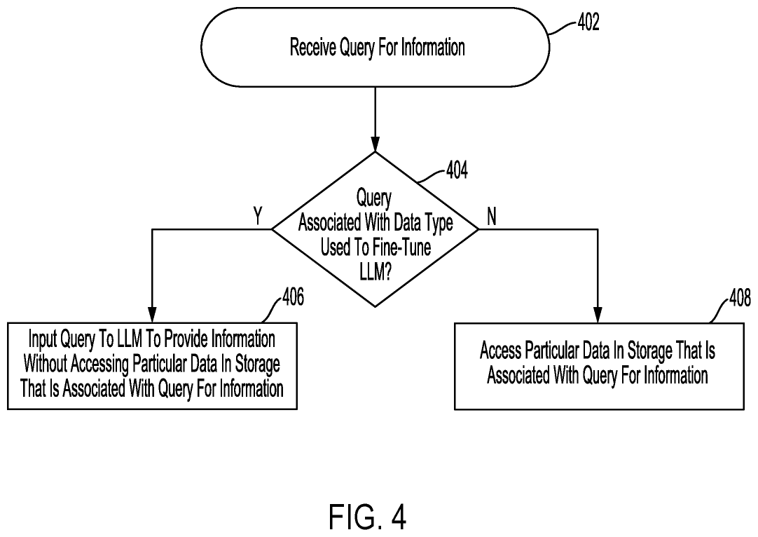

FIG. 4 is a flowchart for a query process according to one or more embodiments. The process of FIG. 4 can be performed by, for example, one or more processors 104 of host device 102 executing query interface 14 and FT data identifier 12 in FIG. 1 or one or more processors 204 of a host device 202 executing query interface 14 and one or more processors 224 of storage system controller 218 executing data identifier 12 in FIG. 2A.

In block 402, a query for information is received by a processor via a query interface executed at a host device. The query may be a textural query for information associated with particular data that is stored in a secondary storage or in a primary storage of a storage system (e.g., secondary storage 26 or primary storage 24 in FIG. 1 or 2B). For example, a user of the host device may input a natural language query concerning specific information associated with one more files or objects stored in a secondary storage of the storage system, such as a list of articles relating to a particular topic or a question about information included in one or more documents.

In block 404, it is determined whether the query for information is associated with a data type that is used for fine-tuning an LLM (e.g., LLM 16 in FIG. 1 or 2A) executed by the storage system. In some implementations, an FT data identifier used to identify data for fine-tuning the LLM, such as in block 304 of FIG. 3, is also used to screen queries for information to determine if a type of data associated with the query is used to fine-tune the LLM. For example, a question about a data type such as company owned emails or technical specification documents that would typically be used by the system to fine-tune the LLM may be treated differently than queries for information about other data types that are not used for fine-tuning the LLM, such as images, videos, or private data. Such screening of queries can improve usage of the query interface by identifying queries that may need access to particular data stored in either the secondary storage or in the primary storage, as opposed to queries that have a higher likelihood of providing a satisfactory response without accessing the particular data stored in the secondary storage.

If it is determined in block 404 that the query is associated with a data type used to fine-tune the LLM, the query is input into the LLM in block 406 to provide information from the LLM without accessing particular data in storage that is associated with the query. In this regard, the particular data associated with the query for information is unlikely to need to be accessed in secondary storage or in another storage, such as a primary storage, to provide a satisfactory response to the query because the LLM has been fine-tuned using a data type of the particular data. As noted above, the storage of data used to fine-tune the LLM in a secondary storage can provide for a more efficient storage of data in the storage system since the use of the LLM can lessen the need to access the data and types of data used to fine-tune the LLM.

On the other hand, if it is determined in block 404 that the query is not associated with a data type used to fine-tune the LLM, particular data associated with the query for information is accessed in storage (e.g., in primary storage or in secondary storage) in block 408. Since the query for information is associated with a data type not used for fine-tuning the LLM, the particular data is accessed in storage to provide a response. In many cases, the data can be accessed from a primary storage that provides a lower latency in accessing the data as compared to a secondary storage used to store data used to fine-tune the LLM. The data may be accessed or retrieved from storage in block 408 to provide the data to the user or the data may be accessed in storage, for example, by the query interface to extract or identify particular portions of the data that may be related to the query to provide information to the user.

Those of ordinary skill in the art will appreciate with reference to the present disclosure that other implementations of the query process of FIG. 4 may differ. For example, block 404 may be omitted so that all queries are input into the LLM and particular data is only accessed from storage if the user is not satisfied with the response and requests access of the particular data from storage. In some implementations, the query process of FIG. 4 may be a temporary process that is used during an initial period of using the LLM while the LLM is still being initially fine-tuned. After fine-tuning, the queries may be input into the LLM without screening for certain data types in block 404 that are used to fine-tune the LLM.

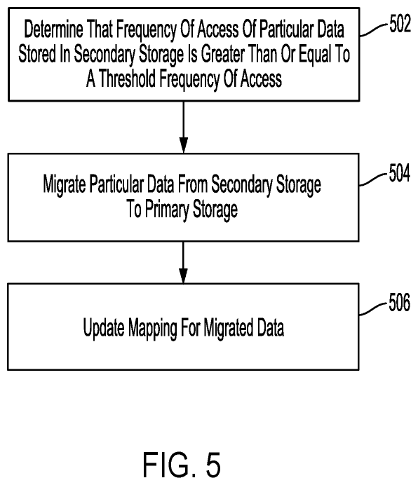

FIG. 5 is a flowchart for a data migration process according to one or more embodiments. The process of FIG. 5 can be performed by, for example, one or more processors 104 of host device 102 in FIG. 1 or one or more processors 224 of storage system controller 218. The data migration process of FIG. 5 may be performed periodically for data stored in secondary storage and/or may be performed for data stored in secondary storage when it is accessed by a host device.

In block 502, it is determined that a frequency of access of particular data stored in secondary storage is greater than or equal to a threshold frequency of access. In some implementations, the particular data may have been accessed by a host device, such as following a request from the host device to access the particular data or as a result of block 408 in FIG. 4 after receiving a query associated with the particular data. The threshold frequency of access may be set in some implementations based on, for example, an available storage capacity of a primary storage that has a lower latency for data access than the secondary storage. In some implementations, an indication of a frequency of access for the particular data may be stored or indicated with the particular data being accessed or may be stored as a part of a logical mapping for the particular data, such as in mapping 18 of FIG. 1 or 2A. The frequency of access may indicate a value such as a low value or a high value in some implementations or may include a count of accesses for the particular data within a predetermined period of time.

In block 504, the particular data is migrated from the secondary storage to a primary storage of the storage system. In some implementations, the particular data or one or more pages including the particular data stored in the secondary storage may be rewritten in the primary storage. The particular data stored in the secondary storage may then be marked as invalid or its storage location in the secondary storage may otherwise be made available for being overwritten with other data to be stored in secondary storage.

In block 506, a mapping is updated for the migrated data to indicate the new storage location for the particular data in the primary storage. In cases where the particular data may have been previously used for fine-tuning an LLM, the particular data may have been migrated due to, for example, the particular data being accessed for other purposes than for responding to queries for information via the LLM.

Those of ordinary skill in the art will appreciate with reference to the present disclosure that other implementations of the data migration process of FIG. 5 may differ. For example, other implementations of the data migration process may also periodically check whether data stored in the primary storage has been accessed less than a lower threshold frequency of access within a predetermined period of time and migrate such data from the primary storage to the secondary storage to conserve space in the primary storage.

The foregoing storage systems involving LLMs can ordinarily provide a more efficient storage system by storing data that may not need to be accessed as frequently as a result of an LLM's fine-tuning in a less expensive and/or a higher data density secondary storage. In addition, the identification of certain types of data that are accessed by users or by specific applications during operation of the storage system can improve the fine-tuning of an LLM by streamlining the fine-tuning and better tailoring the LLM to the actual data being accessed by the users or specific applications of the storage system. Furthermore, the foregoing storage systems for fine-tuning an LLM can facilitate fine-tuning the LLM over time so that the LLM evolves as the data accessed by the users or applications changes over time.

### Other Embodiments

Those of ordinary skill in the art will appreciate that the various illustrative logical blocks, modules, and processes described in connection with the examples disclosed herein may be implemented as electronic hardware, computer software, or combinations of both. Furthermore, the foregoing processes can be embodied on a computer readable medium which causes processor or controller circuitry to perform or execute certain functions.

To clearly illustrate this interchangeability of hardware and software, various illustrative components, blocks, and modules have been described above generally in terms of their functionality. Whether such functionality is implemented as hardware or software depends upon the particular application and design constraints imposed on the overall system. Those of ordinary skill in the art may implement the described functionality in varying ways for each particular application, but such implementation decisions should not be interpreted as causing a departure from the scope of the present disclosure.

The various illustrative logical blocks, units, modules, processor circuitry, and controller circuitry described in connection with the examples disclosed herein may be implemented or performed with a general purpose processor, a GPU, a DSP, an ASIC, an FPGA or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. Processor or controller circuitry may also be implemented as a combination of computing devices, e.g., a combination of a DSP and a microprocessor, a plurality of microprocessors, an SoC, one or more microprocessors in conjunction with a DSP core, or any other such configuration.

The activities of a method or process described in connection with the examples disclosed herein may be embodied directly in hardware, in a software module executed by processor or controller circuitry, or in a combination of the two. The steps of the method or algorithm may also be performed in an alternate order from those provided in the examples. A software module may reside in RAM memory, flash memory, ROM memory, EPROM memory, EEPROM memory, registers, hard disk, a removable media, an optical media, or any other form of storage medium known in the art. An exemplary storage medium is coupled to processor or controller circuitry such that the processor or controller circuitry can read information from, and write information to, the storage medium. In the alternative, the storage medium may be integral to processor or controller circuitry. The processor or controller circuitry and the storage medium may reside in an ASIC or an SoC.

The foregoing description of the disclosed example embodiments is provided to enable any person of ordinary skill in the art to make or use the embodiments in the present disclosure. Various modifications to these examples will be readily apparent to those of ordinary skill in the art, and the principles disclosed herein may be applied to other examples without departing from the spirit or scope of the present disclosure. The described embodiments are to be considered in all respects only as illustrative and not restrictive. In addition, the use of language in the form of “at least one of A and B” in the following claims should be understood to mean “only A, only B, or both A and B.”

What is claimed is:

1. A method performed by a storage system including a primary storage and a secondary storage, the method comprising:
receiving data from an application executing on a host device of the storage system to store the received data;
determining whether the received data is to be used for fine-tuning a Large Language Model (LLM);
determining whether the received data is to be stored in the secondary storage or in the primary storage based at least in part on the determination on whether the received data is to be used for fine-tuning the LLM, wherein stored data is accessed faster by the host device from the primary storage than from the secondary storage; and
in response to determining that the received data is to be used for fine-tuning the LLM, storing the received data in the secondary storage.

2. The method of claim 1, further comprising:
receiving a query for information associated with particular data stored in the secondary storage; and
inputting the query into the LLM to provide the information without accessing the particular data.

3. The method of claim 1, further comprising:
receiving a query for information;
determining that the query for information is not associated with a data type used to fine-tune the LLM; and
in response to determining that the query for information is not associated with a data type used to fine-tune the LLM, accessing particular data associated with the information that is stored in the secondary storage or in the primary storage.

4. The method of claim 1, further comprising determining whether the received data is to be used for fine-tuning the LLM based on at least one characteristic of the received data.

5. The method of claim 1, wherein the secondary storage is a first partition of a storage device of the storage system and the primary storage is a second partition of the storage device, and wherein the secondary storage provides a higher data storage density than the primary storage.

6. The method of claim 1, wherein the primary storage includes one or more first storage devices of a first type and the secondary storage includes one or more second storage devices of a second type.

7. The method of claim 1, further comprising:
determining that a frequency of access of particular data stored in the secondary storage is greater than or equal to a threshold frequency of access; and
in response to determining that the frequency of access of the particular data is greater than or equal to the threshold frequency of access, migrating the particular data from the secondary storage to the primary storage.

8. The method of claim 1, wherein in response to determining that the received data is to be used for fine-tuning the LLM, the method further comprises:
temporarily storing the received data in an intermediate storage of the storage system for fine-tuning the LLM; and
storing the received data in the secondary storage after fine-tuning the LLM using the received data.

9. The method of claim 8, further comprising providing a batch of accumulated data stored in the intermediate storage to at least one processor for fine-tuning the LLM, the batch of accumulated data including the temporarily stored received data.

10. A system, comprising:
a primary storage configured to store data; and
a secondary storage configured to store data that is less frequently accessed than data stored in the primary storage; and
at least one processor, individually or in combination, configured to:
receive data from an application to store the received data;
determine whether to use the received data to fine-tune a Large Language Model (LLM); and
in response to determining that the received data is to be used to fine-tune the LLM, store the received data in the secondary storage.

11. The system of claim 10, wherein the at least one processor, individually or in combination, is further configured to:
receive a query for information associated with particular data stored in the secondary storage;
input the query into the LLM to provide the information without accessing the particular data.

12. The system of claim 10, wherein the at least one processor, individually or in combination, is further configured to:
receive a query for information;
determine that the query for information is not associated with a data type used to fine-tune the LLM; and
in response to determining that the query for information is not associated with a data type used to fine-tune the LLM, access particular data associated with the information that is stored in the secondary storage or in the primary storage.

13. The system of claim 10, wherein the at least one processor, individually or in combination, is further configured to determine to use the received data to fine-tune the LLM based on at least one characteristic of the received data.

14. The system of claim 10, further comprising a storage device, wherein the secondary storage is a first partition of the storage device and the primary storage is a second partition of the storage device, and wherein the secondary storage provides a higher data storage density than the primary storage.

15. The system of claim 10, further comprising a plurality of storage devices, wherein the primary storage includes one or more first storage devices of the plurality of storage devices of a first type and the secondary storage includes one or more second storage devices of the plurality of storages devices of a second type.

16. The system of claim 10, wherein the at least one processor, individually or in combination, is further configured to:
determine that a frequency of access of particular data stored in the secondary storage is greater than or equal to a threshold frequency of access; and
in response to determining that the frequency of access of the particular data is greater than or equal to the threshold frequency of access, migrate the particular data from the secondary storage to the primary storage.

17. The system of claim 10, further comprising:
an intermediate storage configured to temporarily store the received data for fine-tuning the LLM; and
wherein the at least one processor, individually or in combination, is further configured to store the received data in the secondary storage after fine-tuning the LLM using the received data.

18. The system of claim 17, wherein the temporarily stored data forms part of a batch of accumulated data stored in the intermediate storage for fine-tuning the LLM.

19. A system, comprising:
a primary storage configured to store data; and
a secondary storage configured to store data that is less frequently accessed than data stored in the primary storage; and
means for:
receiving data from an application executing on a host device to store the received data;
determining whether the received data is to be used for fine-tuning a Large Language Model (LLM);
determining whether the received data is to be stored in the secondary storage or in the primary storage based at least in part on the determination on whether the received data is to be used for fine-tuning the LLM; and
in response to determining that the received data is to be used for fine-tuning the LLM, storing the received data in the secondary storage.

20. The system of claim 19, further comprising means for:
receiving a query for information associated with particular data stored in the secondary storage;
inputting the query into the LLM to provide the information without accessing the particular data.
